(19) United States
(12) Patent Application Publication
(10) Pub. No.: US 2020/0294152 A1
(43) Pub. Date: Sep. 17, 2020

(54) Method of Placing Insurance Coverage With Several Insurers

(71) Applicants: Robert W. Fletcher, Louisville, KY (US); Robin Fletcher, Georgetown, IN (US); Curtis R. Droege, Richmond, KY (US)

(72) Inventors: Robert W. Fletcher, Louisville, KY (US); Robin Fletcher, Georgetown, IN (US); Curtis R. Droege, Richmond, KY (US)

(73) Assignee: Intellectual Property Control Corporation, Louisville, KY (US)

(21) Appl. No.: 16/298,055

(22) Filed: Mar. 11, 2019

(51) Int. Cl. G06Q 40/08

(52) U.S. Cl. CPC G06Q 40/08; G06T 11/206

(57) ABSTRACT

A computer-implemented method for placing insurance coverage with insurers includes a broker user interface, and an insurer user interface for displaying a graphical representation of an insurance tower. The insurer user interface provides one or more insurers the ability to select, bid or request variants of the insurance tower. A blockchain system is used for authorizing one or more bids or variants in the insurance risk towers.

### CROSS REFERENCE TO RELATED APPLICATIONS

This application is a continuation-in-part of U.S. patent application Ser. No. 16/283,505, filed Feb. 22, 2019.

### STATEMENT REGARDING FEDERALLY SPONSORED RESEARCH OR DEVELOPMENT

Not applicable.

### FIELD OF THE DISCLOSURE

This invention relates to a computer-implemented method for providing complex and large limit insurance which relies on block chain technology for authentication throughout the life of the insurance policy.

### BACKGROUND OF THE DISCLOSURE

Large and complex insurance risks are often more than one insurance carrier (or insurer) may elect to insure. This is often the case when insuring large buildings, large corporations, or when unique insurance is required, such as insuring the transport of explosive material. In these cases, the total risk may be divided into risk layers, in which a primary layer is covered by a primary insurer, and additional layers of exposure (“excess layers”) are covered by different insurers. The entity that purchases the insurance is referred to as the “insured”.

Primary and excess layers are stacked vertically, wherein the vertical axis represents loss limits that increase with increasing layers. The total insurance risk, comprised of primary and excess layers, is known as an insurance “tower”. The liability of each layer must be exhausted by any preceding (or junior) layer before any liability is assumed for the next successive (or senior) layer. As a result, insurers closer to the bottom (or base) of the tower have a higher probability of having to satisfy a claim against the policy. In exchange, the Insurer that assumes a higher risk is rewarded by assuming a higher relative percent of the insurance premium. There are multiple exceptions, however, which affect the compensation to the insurer. There is also further segmentation (“risk compartments”) possible within a layer, referred to as “risk compartments” that may affect compensation to the insurer. These risk compartments may include, for example, geography, intellectual property, cyber, types of insurance controversy, and sub-segments within each of these.

It is the responsibility of a broker to ensure the tower is complete and that it addresses the complete liability for which the insured requests coverage. With multiple layers and specialties, the broker's responsibility to the insured for complete risk coverage is complex and arduous. If there are incomplete risk layers or risk compartments, the broker may reach for creative solutions to fill those compartments. For example, the broker may increase the compensation to the insurer, further segment the remaining risk to be filled, or agree to specific terms or policy language to ensure the tower is complete. These last remaining risk compartments have the potential to delay binding of coverage for the insured, and may result in misunderstanding at the time of a claim against the insurance policy.

Currently, there is no uniform system for managing a complex tower. There are thousands of brokers developing towers with each having their own unique methods or forms for managing the purchase, modification, and binding of coverage with various insurers. The administrative costs to brokers for creating and managing a tower are extensive. In addition, there are multiple errors that can and do occur in managing a complex tower which includes lack of coverage even though coverage was assumed by the insured.

What is needed is a method of building and managing large and complex insurance towers that are capable of automated adjustments, and confirmation that insurance coverage is maintained in compliance with the insured's expectations throughout the policy period and any follow-on renewals of the policy.

### SUMMARY OF THE DISCLOSURE

The present disclosure describes a method for insurance brokers to place insurance coverage with a multiplicity of insurance carriers over the Internet using a computer and allowing the insurance carriers to bid for and bind percentages and limits of an insurance tower.

The method also provides for insurance carriers to adjust any remaining risk layers or risk compartments and to receive real-time feedback of any corresponding compensation adjustment.

The method also provides for insurance carriers to enter information into a blockchain system that includes encryption protocols for securely managing the insurance tower. The blockchain system verifies certain protocols for the brokers, the insurance carriers, and the insureds. Protocols include policy documents, sequence of claims disbursement based on junior and senior layers, verifications of coverage restrictions, fund transfer, and others.

### DESCRIPTION OF THE DRAWINGS

FIG. 1 illustrates a system architecture for one embodiment of the present disclosure;

FIG. 2 illustrate a two-dimensional insurance risk tower according to an embodiment of the present disclosure;

FIG. 3 illustrates a three-dimensional insurance risk tower according an embodiment of the present disclosure;

FIG. 4 illustrates the process flow from the Broker's point of view.

FIG. 5a shows a chart of % Premium and % Risk as a function of risk layers;

FIG. 5b shows a group of risk factors for various types of insurance;

FIG. 6 shows a flowchart for calculating real-time adjustments in insurance risk towers that is associated with a bid or a variance;

FIG. 7a shows a broker user interface (BUI) or insurer user interface (IUI);

FIG. 7b shows a private user interface (PUI);

FIG. 8 shows a sample table of variables used to calculate variants;

FIG. 9 illustrates a system architecture for a transaction system;

FIG. 10a shows an entry view to a broker user interface (BUI);

FIG. 10b shows an additional view of a broker user interface (BUI);

FIG. 11 shows an entry view to an insurer's user interface (IUI);

FIG. 12 shows an edit view to a broker user interface (BUI).

### DETAILED DESCRIPTION

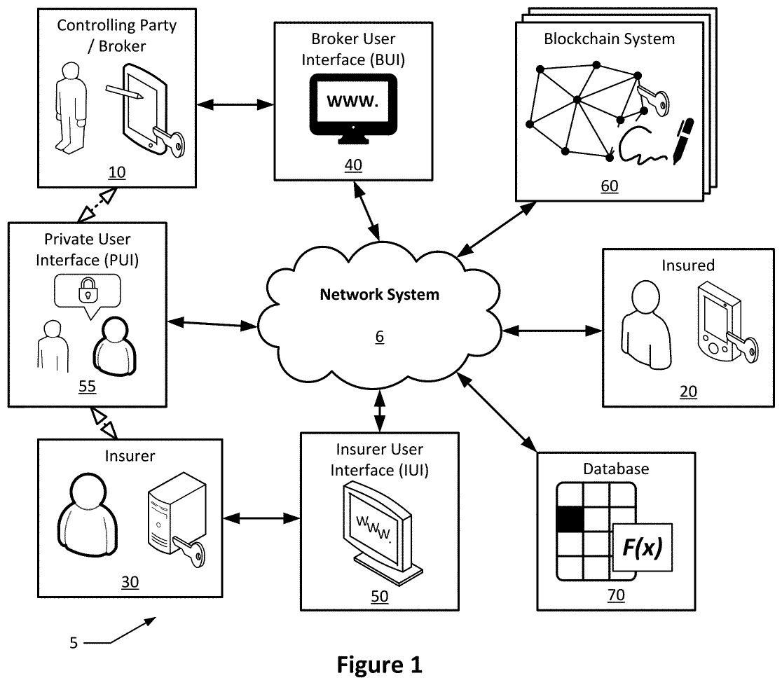

FIG. 1 illustrates a system architecture for an insurance tower management (ITM) system (5) that is created by a controlling party or broker (10). The ITM system (5) enables a complex insurance agreement to be formed on behalf of an insured (20) which involves one or more insurers (30). The ITM system (5) is enabled by a computer network system (6), which connects the various computing devices used by brokers (10), insureds (20), and insurers (30). These computing devices may be, for example, desktop computers, laptop computers, tablet computers, and smart phones. Each computing device used by a user will likely include a user interface, which are normally physical devices that are connected to the computers for interacting with the users. User interfaces may include graphical displays (or monitors), keyboards or other touch input devices, mice, audio devices such as microphones and speakers, and virtual and augmented reality interfaces. The computer network system (6) further connects a blockchain system (60), and a database (70). The computer network system (6) is a computing system that provides network interconnectivity between cloud-based or cloud-enabled applications, services and solutions. The computer network system (6) may be a cloud-based network or a cloud-enabled network.

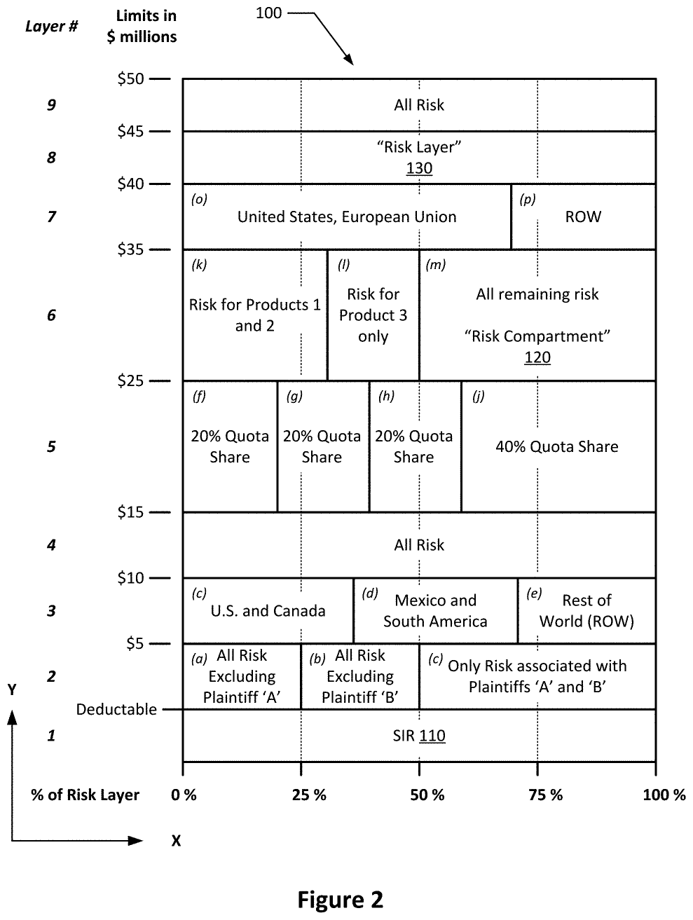

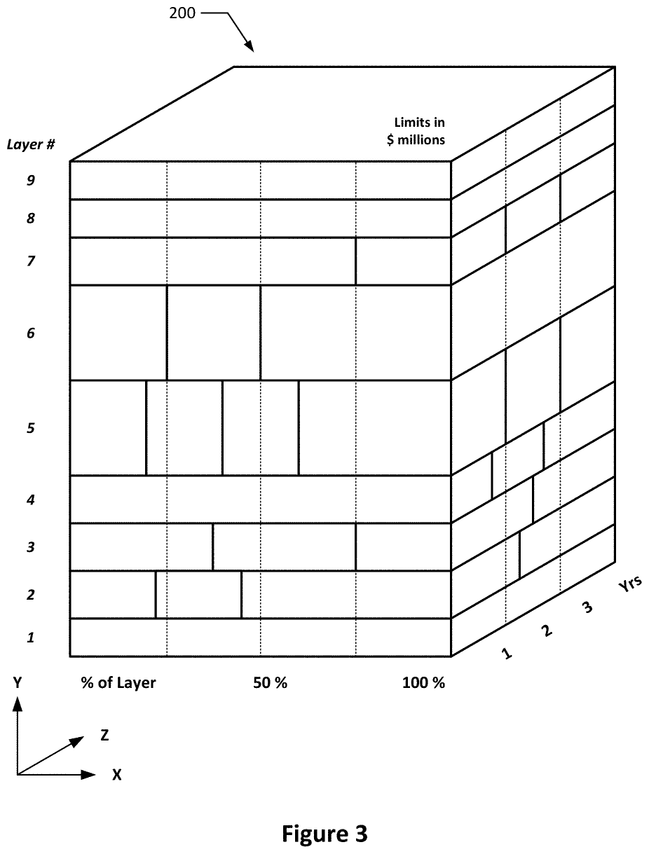

The ITM system (5) provides different user interfaces depending on the user's permissions and authority in the ITM system (5). Brokers (10) are provided with a secure broker user interface (BUI) (40) for creating and managing one or more insurance towers. Insurers (30) are provided with a secure insurer user interface (MI) (50) with viewing and limited change capability of one or more insurance towers (100 as shown in FIG. 2, or 200 as shown in FIG. 3). There is a private user interface (PUI) (55) that may be employed during negotiations between the broker (10) and the insurer (30). The ITM system (5) includes a database (70) which includes data, and which is capable of performing real-time calculations based on proposed changes to the insurance tower (100 or 200). A blockchain system (60) enables bidding for, and binding of, insurance coverage in addition to other functionality. The blockchain system (60) provides the transaction process with confidentiality, change control, and bid-to-authorization conversion at the completion of contract requirements.

FIG. 2 provides a graphical representation of a two-dimensional insurance tower (2D tower) (100), in which the x-axis represents the percentage of a risk from 0% to 100%, and the y-axis represents the limits of coverage in monetary units. Units of U.S. dollars ($) are used throughout the Figures. In this example, limits of $50M are required by the insured (20), which is often difficult for any one insurer (30) to assume, thereby creating a desire to spread the risk among multiple insurers (30) using an insurance tower (100 or 200). The limits are stratified into risk layers (130) to enable insurers (30) to assume smaller portions of the total risk. The risk layers (130) are numbered for ease of communication, starting at the bottom from “1”. Risk layers (130) may be further divided into risk compartments (120), which are each labeled (a) through (p) starting from layer 2 and ending in layer 7 as shown.

In FIG. 2, layer 1 is associated with a self-insured retention (SIR) (110). An SIR (110) is similar to a “deductible” that is common with most insurance policies, but an SIR (110) does not reduce the total available limits. In other words, the limits of the insurance tower (100 or 200 of FIG. 3) start above the SIR (110), not below (although a standard deductible may be used instead of an SIR). Layer 2 is associated with limits from $0 to $5M. This is the first layer of insurance which will require a response for any claim against the insurance policy that is above the SIR (110). In the example shown in FIG. 2, layer 2 is subdivided into three risk compartments (120) associated with specific plaintiffs: (a) is “All Risk Excluding Plaintiff ‘A’”, (b) is “All Risk Excluding Plaintiff ‘B’”, and (c) is “Only Risk associated with Plaintiffs ‘A’ and ‘B’”. This is a complex scenario intended to represent a preference that two or more Insurers (30) share the risk of layer 2 in an uncommon way. The insurer (30) that is responsible for the claim will be determined by the parties involved in a controversy. In this scenario, if a controversy arises between the Insured (20) and plaintiff ‘A’, the Insurer for the risk compartment (120) labeled (c) is responsible. Insurers (30) responsible for risk compartments (a) and (b) assume no responsibility for the claim.

Continuing with the examples shown in FIG. 2, Layer 3 is associated with limits between $5M and $10M. This layer is also subdivided into three risk compartments (120) in this case based on geography. Risk compartment (c) is associated with controversies in the “U.S. and Canada”, risk compartment (d) is associated with controversies in “Mexico and South America”, and risk compartment (e) is associated with all countries except those names, which is the “Rest of World (ROW)”. Layer 3 will be called upon to respond to any claim against the insurance policy that is above the SIR (110) and above Layer 2. Thus, Layer 2 will have been exhausted prior to any requirement for layer 3 to respond. If there is a controversy within the limits of $5M and $10M the question of where the controversy is occurring will determine which insurer (30) is responsible. If the controversy is in Canada, the insurer responsible for risk compartment (c) is responsible. If the controversy is in Canada and Ireland, however, there will be shared responsibility between the insurers (30) involving risk compartments (c) and (e). A further example is shown in layer 5, which is the layer between $15M and $25M. In this layer, there are shown four risk compartments (f) through (j) each having a quota share of 20% except for (j), which is 40%. This is relatively common in the insurance industry. Layer 5 will be called upon to respond for any claim against the insurance policy that is above layer 4. For any claim between the limits of $15M and $25M, all four insurers (30) will respond in the proportion they chose, which will be 20% or 40%.

FIG. 3 expands on the concept of the 2D tower 100 shown in FIG. 2 by introducing a third (z) axis, which is the time frame in which the insurance policy is to be in effect. This time frame, normally described as the policy term or policy period, is shown in FIG. 3 having a time frame of 3 years, forming a 3D tower 200. Each year along the z-axis is shown by a vertical dotted line. In the Figure, layers 5 and 7 are shown (by solid lines) to have one-year policy periods, wherein the solid lines are coincident with the vertical dotted lines. Layers 2, 3, and 4 also have solid lines which indicate policy periods less than the full 3 years, although the solid lines are not coincident with the dotted lines. This is intentional to illustrate that the policy term may be defined by a time period other than years or may be defined by an event such as a product announcement, a product retirement, or some other trigger event. Insurers (30) may elect to insure only one of the policy periods, or may elect to insure two or all for a given risk layer (130) or risk compartment (120) of FIG. 2.

The presence of an overlapping bid may generate a new alternative insurance tower (100 or 200) automatically, or in the alternative, multiple empty insurance towers (100 or 200) may be initiated in the first place, to allow more than one overall scenario from the start. This is the more likely embodiment if insurers are paying (for example, in electronic coin) to submit a bid. Bidders could pay to generate a fresh insurance tower (100 or 200) and claim their desired stake and their proposed terms. This separate insurance tower (100 or 200) could be available for view by the other paying participants. One way to visualize overlapping bids is, for example, a 3D insurance tower (200) with different colors, preferably allowing views of the 3D tower (200) by scrolling between overlaying tower matrices in the z axis, and possibly scrolling through the x-z or y-z towers on the third axis, such that the alternatives of the risk can easily be seen and understood. In the alternative, the z axis may represent the risk over time, in which case separate 3-D towers (200) may be available with alternative or overlapping bids. Finally, alternatives in the 3-D tower (200) over various time frames could be represented in any known 4-D representation, such as a video representation rather than a snapshot, or in the alternative, policy length or overlapping bids may be represented in another 3-D way, such as color or shading.

The descriptions of FIGS. 2 and 3 illustrate the complexity that may be associated with an insurance tower (100 or 200). The broker (10) has a fiduciary duty to the insured (20) to create an insurance tower (100 or 200) that comprehensively addresses the risk as requested by the insured (20). For a large corporation that requires limits up to $50M as shown in the Figures, some form of insurance towers such as a 2D tower (100) or 3D tower (200) are common to spread the risk and enable specialty insurers (30) to assume specific specialty risk, such as intellectual property risk.

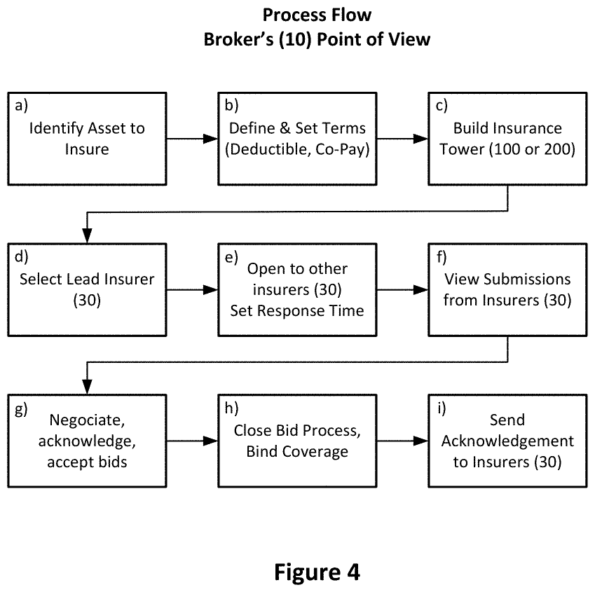

As illustrated in FIGS. 2 and 3, the process of developing an insurance tower (100 or 200) is complex. The broker (10) must consider several factors in an effort to provide insurance coverage to the insured (20). Following is a flowchart further describing the process which corresponds to FIG. 4:
a) The broker (10) identifies the asset to be insured. For complex businesses, there may be several types of insurance that need to be considered;
b) The broker (10) defines the types of insurance, and establishes insurance terms such as limits of coverage, co-pay, deductible or self-insured retention (SIR 110);
c) The broker (10) builds the insurance tower (100 or 200), which may be a text document or a visual representation. The insurance tower (100 or 200) includes limits for each risk layer (130). Risk compartments (120) include limits as part of a risk layer (130) in addition to any special considerations for those risk compartments (120);
d) A lead insurance carrier is selected, which is typically the primary insurer (30);
e) The insurance tower (100 or 200) is opened for a time period for other insurers (30), often referred to as secondary insurers (or reinsurers) (30) to assume selected risk;
f) The broker (10) views submissions from secondary insurers (30);
g) The broker (10) may enter into negotiations with insurers (30), or may simply acknowledge and accept bids as further discussed in this disclosure;
h) Once the time period for bids has expired, or once the insurance tower (100 or 200) is completely insured, the bid process is closed and insurance coverage is bound;
i) An acknowledgement is sent to the various insurers (30) confirming their commitment to the insurance tower (100 or 200).

It should be noted that each insurer (30) may choose a specific risk layer (130) or risk compartment (120) according to their desire to assume that risk in the insurance tower (100 or 200). In exchange, the insurer (30) is compensated by receiving a portion of the insurance premium (% Premium), which Premium is the amount paid by the insured (20) for assuming risk in the insurance tower (100 or 200). It is the broker's responsibility to assess the risk, to determine a fair % Premium for each risk compartment (120) or risk layer (130), and to ensure that the insurance tower (100 or 200) is completely insured. This is a complex undertaking. Once an insurance tower (100 or 200) has been developed by the broker (10), there is normally a limited time period (say, 10 days) in which insurers (30) may opt to accept one or more risk compartments (120) and risk layers (130), and a limited time period for the broker (10) to complete the insurance tower (100 or 200) so that insurance coverage may start according to the requirement of the insured (20). Often, insurers (30) request changes to the insurance tower (100 or 200). Given the complexity of the originally constructed insurance tower (100 or 200) which includes risk compartments (120) and risk layers (130), and given the time pressure, it should be self-evident that errors, misunderstandings, miscalculations, and gaps in coverage are likely to result if changes in the insurance tower (100 or 200) rely on one person or even a team of persons to continually update the insurance tower (100 or 200).

The insurer (30) does not necessarily receive a proportional percentage of the premium. Insurers (30) have different ways of calculating premium, and for various reasons (their AM BEST rating, their claims handling reputation, their costs, their capacity) they may bid a higher premium than others for the same risk compartment (120). In one embodiment, insurers (30) may bid on risk compartments (120) in the insurance tower (100 or 200), stating the scope, limits and premium. When insurers (30) compete on the basis of premium, the broker (10) may enjoy a competitive premium. The broker (10) can select among competing bids by insurers (30), having his/her own view of the value of each bid. The broker (10) could be enabled to eliminate portions of the risk from the insurance tower (100 or 200) altogether, if that portion is ultimately not a good value, which in essence redefines the original scope of the insurance tower (100 or 200). The risk compartments (120) in the insurance tower (100 or 200) do not have to be pre-determined but could in some embodiments be open for bid at first, with missing segments then to be completed in once major or early bidder have indicated their early bids. The terms of the various bids can be made visible to all participants, and alternative bids be made on the same risk compartments (120) by competing insurers (30).

If the rules allow, competing bids which differ in terms or scope could overlap not directly substitute for one another), which may result in an alternative insurance tower (100 or 200) proposal, or in overlapping boundaries of a risk layer (130) or risk compartment (120) within a single insurance tower (100 or 200). This result may require selection between competing bids by a decision maker during the bidding process, or by negotiation between the two competing bidders on the overlapping portions and respective resubmission of the bids, or by automatically dividing/diluting the overlapping risk between the competing bidders, or by pre-set rules stating, for example, that risk compartments (120) are defined by the first offer to claim them.

One of many challenges with insurance towers (100 or 200) having the level of complexity described herein is appropriately determining the compensation to the insurer (30) in terms of percent of premium (% Premium) for assuming a specific risk, such as a risk layer (130) or risk compartment (120). Typically, % Premium requires input from underwriters which relies on actuarial data in addition to other risk-specific data. If an insurer (30) prefers a specific risk that has not been contemplated by the underwriters, there may be a delay of several days to assess the new risk as defined by the insurer's (30) request. Even so, there is a need for % Premium to be calculated essentially in real-time. Real-time risk assessment requires an understanding of the variables that may influence the risk of unknown scenarios which may be requested by the insurers (30).

It may be that the insurer (30) merely would like to propose a change in % premium for a specific risk layer (130) or risk compartment (120). This is referred to as a “bid”. It may be that the insurer (30) would like to propose a substantial change in the insurance tower (100 or 200) such as fragmenting a risk layer (130) into risk compartments (120) or changing the limits of a risk layer (130). This is referred to as a “variance” or “variants” in the plural.

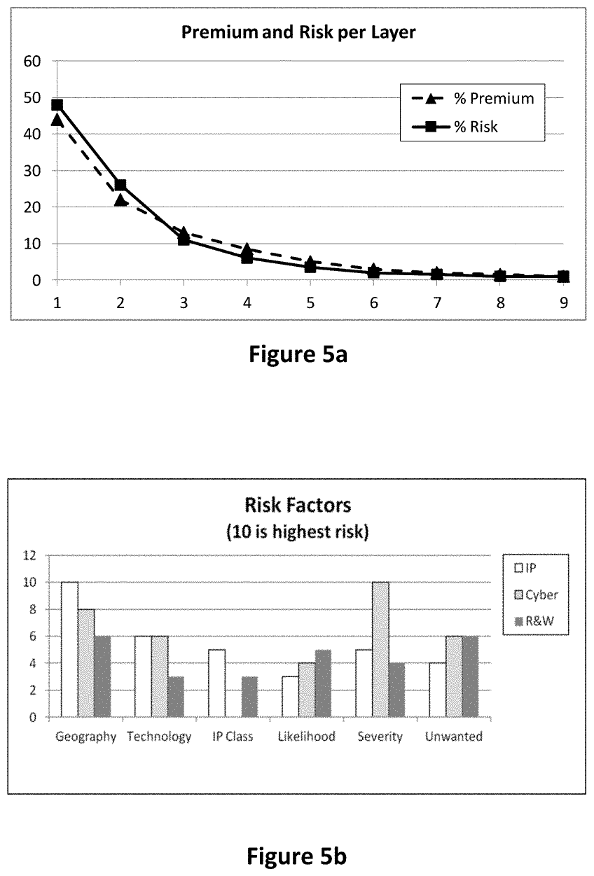

To enable real-time calculations of one or more variants multiple data systems are required. FIG. 5a shows a chart of percent premium (% Premium) and percent risk (% Risk) as a function of risk layers. In the Figure, five layers are shown on the x-axis. The chart shows that 60% of the risk is assumed in layer one, 22% of the risk is associated with layer two, 14% of the risk is associated with layer three, 9% of the risk is associated with layer four, and 5% of the risk is associated with layer five. This is reasonable considering that all the liability of layer one must be exhausted before any liability will pass to the next layer. Often, a claim against the insurance policy may be settled within the first layer, resulting in no payout from layer two. Likewise, for each successive layer above the base layer, there is progressively less risk. The percentage of the insurance premium is shown in the Figure to be proportional to the percent risk, although it may not be directly proportional. It is common for the premium and risk curves to follow a second order curve, as shown.

In FIG. 5b, representative variables are shown for three types of insurance: IP (Intellectual Property), Cyber, and R&W (Representations & Warranties). The variables are a subset of those shown in FIG. 2, which include Geography, Technology, IP Class, Likelihood, Severity, and Unwanted. In the Figure, Geography is shown to have a high-risk factor for IP insurance. It is well-known that the United States is involved in substantial litigation due in-part to a traditionally large market (resulting in potentially large damages) and laws that are generally favorable toward plaintiffs. In Europe, there are substantial differences even between EU member countries such as Germany and the UK (England and Wales). Court procedures, appeals procedures, fee shifting (such as loser pays), and cross-border enforcement procedures vary substantially from country to country. Substantially higher risk of litigation, or higher costs, results on a country-by-country basis. Cyber insurance is shown to have a high severity if a claim is made, also resulting in a high-risk factor given the nature of a breach that may result in disclosing critical information from millions of customers. Each of these risk factors enables inputs to equations for calculating % Premium for layers or risk compartments.

FIG. 5b shows a table of variables and scale factors for the three risk compartment scenarios shown in FIG. 5a. These may be used to solve for Equation 1 and other similar equations to approximate the risk and, therefore, the % Premium for any risk layer or risk compartment in an insurance tower (100 or 200).

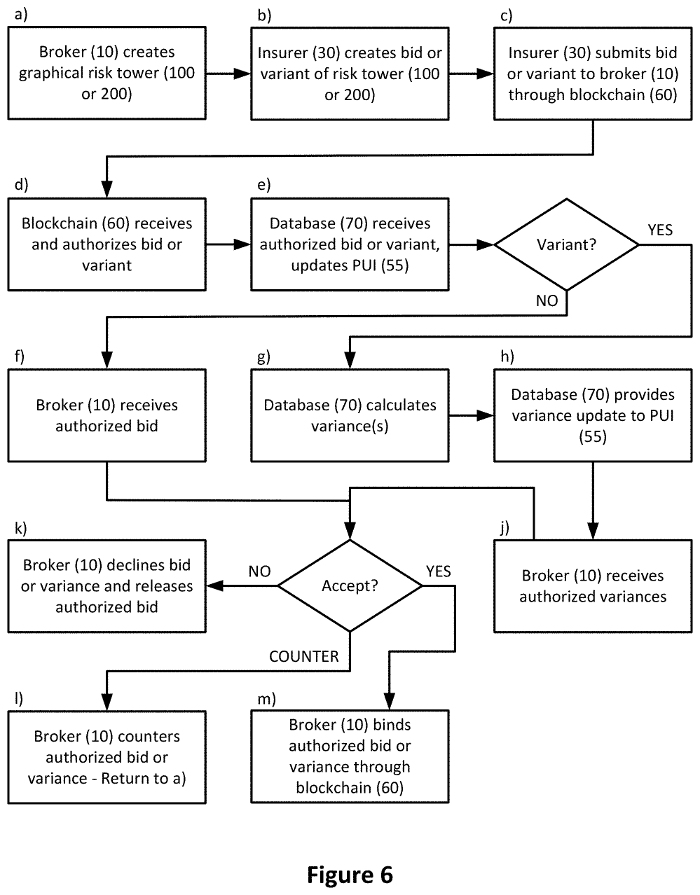

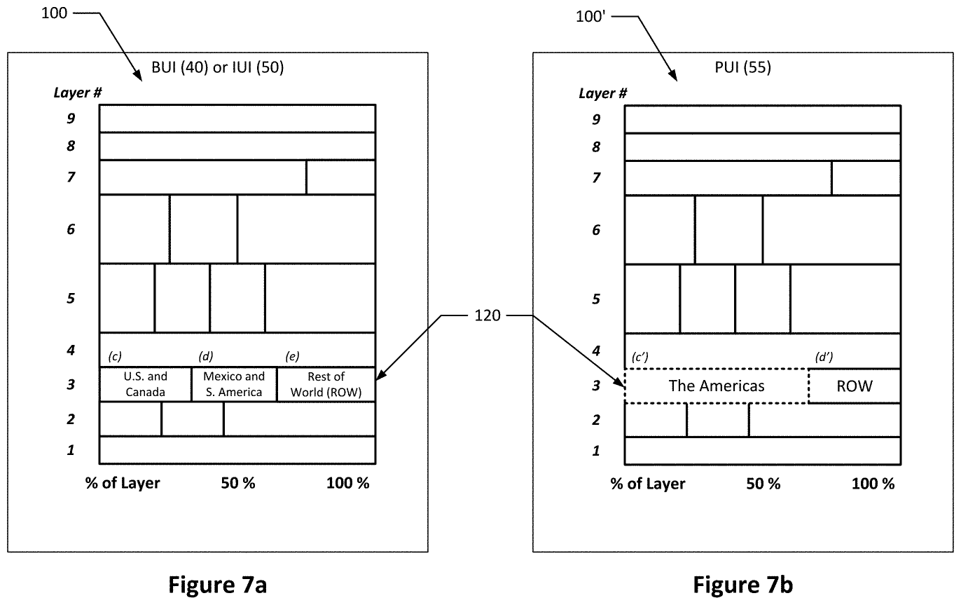

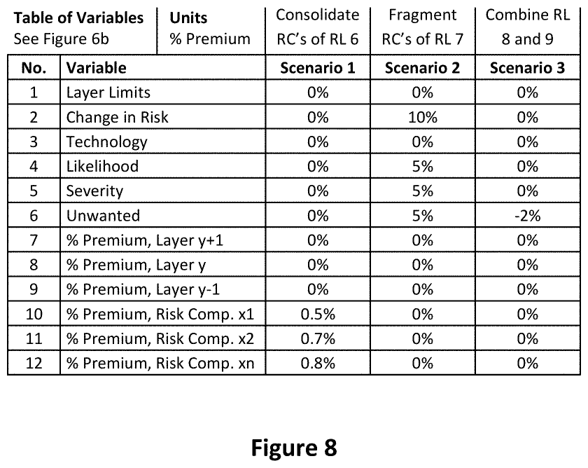

A key element of the process for managing any changes to the insurance tower (100 or 200) is the blockchain system (60). The blockchain system (60) provides an interface for any formal communications which includes, for example, an insurer (30) placing a bid for a risk layer (130) or risk compartment (120), proposing a change to a risk layer (130) or risk compartment (120), and a broker (10) binding the bid of an insurer (30). At the time of finally binding the insurance, the blockchain system (60) is used, for example, to receive the insurance premium from the insured (20), to properly disperse the % premium to the various insurers (30), and to disperse any brokerage fees to the broker (10). At the time of any claim, the blockchain system (60) may be used to release funds from an insurer (30), to verify that an insurer's (30) commitment has been satisfied, and to trigger the release of funds from the insurer (30) having the next level of responsibility, if required. The blockchain system (60) is integral to the process shown in FIG. 6.

In FIG. 6, the process for negotiating and binding coverage in the insurance tower (100 or 200) is described:
a. The broker (10) creates a graphical insurance tower (100 or 200) having risk layers (130) and optionally risk compartments (120);
b. The insurer (30) creates a bid or variance for a risk layer (130) or risk compartment (120) of the insurance tower (100 or 200);
c. The insurer (30) submits the bid or variance to the broker (10) through the blockchain system (60);
d. The blockchain system (60) receives and authorizes the bid or variance, committing the insurer (30);
e. The database (70) receives the authorized bid or variance, processes the bid or variance, and updates the PUI (55);
f. If the insurer (30) requests a bid, it is received by the broker (10) which may (k) decline the bid or variance, which then results in the blockchain system (60) releasing the authorized bid back to the insurer (30). Alternately, the broker (10) may counter (l), in which the broker (10) would respond with an alternative to the bid. If the broker (10) counters (l), it has the effect of restarting the proposal process as in (a) of FIG. 6. If the broker (10) accepts the bid (m), the blockchain system (60) confirms and binds coverage for the risk layer (130) or risk compartment (120) in question;
g. If the broker (10) receives an authorized variance through the blockchain system (60); the database (70) calculates the effects of the variance, and (h) updates the BUI (40) and IUI (50);
j. The broker (10) receives the authorized variance, and makes a decision to decline (NO), accept (YES), or counter;
k. If the broker (10) declines the authorized variance, the blockchain system (60) releases the authorized bid back to the insurer (30);
l. If the broker (10) counters the authorized variance, it has the effect of restarting the proposal process as in (a) of FIG. 6;
m. If the broker (10) accepts the authorized variance, the broker (10) binds the agreement through the blockchain system (60).

In general, insurance towers (100 or 200) in progress are not typically public information. Access may be granted on any traditional selective basis, or access to the information may optionally be available in exchange for information or services by barter, by virtue of membership in an organization, or may be purchased for electronic payment or credit in currency local to the inquirer, in a chosen national currency, or by special electronic coin, whether or not the coin is consumable.

The insurance tower (100 or 200) need not have pre-set risk layers (130) and risk compartments (120), but could be first-come first serve, with only the total limits and scope of coverage and optionally the duration of coverage specified initially as the bounds. Again, optionally, the broker (10) can change these bounds at will, as the bidding progresses, in seeing that a particular aspect of the coverage is not bid upon or is not a good value. The broker (10) might decide that the entire insurance tower (100 or 200) is not generating enough interest, and change the SIR (110) or limits requested, or may accept one large bid from a single insurer (30), whether it differs from the original specifications, that is contingent upon exclusivity or closing all subsequent bidding.

The bidding and variant process need not be worked out prior to finalizing an insurance tower (100 or 200), as described here above, but could collect and hold pending alternative variants. Rules may automatically accept bids and “variants” or may hold “variants” pending for a specified time in preference for non-variant bids.

A financial charge may be imposed to access the website or membership/subscription to the website, or to access a particular insurance tower (100 or 200) for a risk or set of risks, and also optionally a charge may be imposed to make a bid on particular compartments within particular insurance towers (100 or 200). The price to access or bid may vary, with less desirable worksheets or compartments being free to access or to bid upon.

For complex financing terms associated with insurance transactions or otherwise falling within the scope of this invention, for example, use of blockchain is advantageous. In these scenarios, a series of documents must be signed in a specific order to transfer assets, establish holding companies, and/or agree to pay. All aspects of these complex agreements may be executed by the correct parties, in the right order, within a specified time frame, electronically in the form of “smart contracts.” This programming allows for a complex transaction to be executed as intended and agreed my multiple parties and can provide that contingent previous steps may be nullified if later steps are not completed accurately or timely. Under these smart contracts, the document text is also safely preserved in an unaltered state between negotiation and signing and verified during closing of the insurance tower or series of financial contracts supporting an insurance policy. Once bids are accepted by the broker (10), each individual purchase transaction can be run by smart contract using blockchain, with output being the final agreement between all participating parties.

The present disclosure is also useful in general financing situations or crowd funding, independent of insurance, such as funding construction projects or investing in startup businesses, and the like.

It should be noted that the insurer (30) is not limited to submitting only one bid or variance. In a preferred embodiment, insurers (30) may submit any number of bids or variants.

Variants may be proposed to the broker (10) which may include, for example, a change to the graphical representation of the insurance tower (100 or 200). These changes may not be shown to all insurers (30) or, if there is a team of brokers (10), may not be shown to all brokers (10) until the negotiation is complete. Thus, in a preferred embodiment, bids or variants are best negotiated through a private user interface PUI (55). This is shown in FIGS. 7a and 7b. FIG. 7a shows a sample BUI (40) or IUI (50) of the 2D tower (100). In particular, risk layer 3 shows a risk layer (130) comprised of three risk compartments (120) including “U.S. and Canada” labeled “(c)”, “Mexico and S. America” labeled “(d)”, and “Rest of World (ROW)” labeled “(e)”. A private user interface (PUI) (55) is shown in FIG. 7b. In this example, an insurer (30) proposes a variance to layer 3 in which (c) and (d) are to be combined into one risk compartment (120) labeled (c′). The remaining risk compartment (120), ROW (d′), remains unchanged.

FIG. 7b shows the proposed change to the risk compartments (120) represented graphically by dashed lines, although any number of graphical methods may be used. For example, a color change, a shadow, on-off blinking, font change, or separate features or icons such as arrows (not shown) may be used to indicate a proposed change by an insurer (30). This is a structural change to the risk compartments (120), wherein three risk compartments (120) are reduced to two. Other structural changes include combining two or more risk layers (130) into fewer risk layers (130), dividing one risk layer (130) into two or more, changing the limits of a risk layer (130), and adding risk compartments (120) to a risk layer (130).

Now turning to a discussion of variance calculations, we refer again to FIG. 2. In the Figure there are shown exemplary variables which comprise limits of coverage (including lower and upper limits), percentages of a risk layer (130), risk compartments (120), and types of risk compartments (120). Examples of the types of risk compartments (120) include geography, products, coverage against opposing parties, time limits, and trigger events.

The variance may result in a change to the structure of the insurance tower (100 or 200) and in changes to the % of premium. These changes are a function of multiple variables which includes, for example, the limits assumed within a layer, the % of Premium for the layer below and above, the change in risk factors associated with the proposed risk compartment (120), the technology, the likelihood of a controversy, the estimated severity based on intellectual property classification (“classification index”), and the likelihood of another Insurer (17) assuming the unwanted risk remaining in the risk layer (130).

The following are sample equations used for providing real-time feedback to Insurers (30) and brokers (10) for any changes made to an insurance risk tower (100 or 200).

### Risk Compartment Consolidation (RCC)

Within a risk layer (130), there is a % Premium (PP) that is required. Changes within a risk layer (130) may result in risk compartment (120) consolidation or fragmentation. In consolidation, a risk layer (130) had previously been divided into risk compartments (120). Consolidation is merely combining one or more risk compartments (120) (RC1+RC2, . . . ) according to Equation 1 below.

PP(RC1)+PP(RC2)+PP(RC3)+PP(RCn)=PP(RCC) Eq. 1:

### Risk Compartment Fragmentation (RCF)

Risk compartment (120) fragmentation may include any number of variables, depending on the nature of the risk, and the change in potential likelihood and/or severity of a claim. If an insurer (30) requests that a risk layer (130) be fragmented into risk compartments (120), there is a potential that one or more remaining risk compartments (120) may not be attractive to other insurers (30). Yet, all risk compartments (120) and risk layers (130) must be insured to provide the requested insurance coverage to the insured (20). Therefore, one risk factor is an “unwanted” risk factor as referenced in the discussion of FIG. 5b. If an insurer (30) requests that a risk layer (130) be fragmented into risk compartments (120), it is not unreasonable to reduce the % premium disproportionately for the requested risk compartment (120). It is therefore acceptable for the sum of risk compartments (120) to result in less % premium than the % premium of a risk layer (130), as shown in Equation 2 wherein RL=“risk layer”.

PP(RLn)/Σ(Risk Factors)/# RCs=RCF % Premium, where(RCF % Premium≤100% of risk layer(130)) Eq. 2:

### Risk Layer Limits Change (RLL)

If an insurer requests that the limits of a risk layer (130) (or risk compartments (120) within a risk layer (130)) be changed, there are several risk factors which may influence the % premium. For this example we reference layer 8 of FIG. 2 in which a single risk layer (130) includes limits between $40M and $45M. The change may include fragmenting risk layer (130) limits, consolidating one or more risk layers (130), or merely changing the limits to a different value. If an insurer (30) requests reduced limits of $40M to $43M, for example, there is the burden of adding an additional risk layer (130) having limits of $43M to $45M, or increasing the limits of layer 9. In layer 9, the limits in FIG. 2 are shown to be $45M to $50M. The limits of layer 9 may be increased by $2M, resulting in limits from $43M to $50M. Changing the limits of a risk layer (130) involves several variables, including adjacent risk layers (130) that are directly affected, and potentially any adjacent risk layers (130) that are not directly affected. See Equation 3.

Avg.(Affected RL's)/(1+Σ(Risk Factors))=RLL % Premium, where(RLL % Premium≤100% of risk layer(130)) Eq. 3:

FIG. 8 shows a table of variables which are used in Equations 1 through 3. In the Figure, variables are listed and numbered 1 through 12. There are three scenarios shown in the Figure applying equations 1 through 3, respectively. Scenario 1 involves the consolidation of risk compartments (120) shown in risk layer 6 of FIG. 2. Scenario 2 involves the fragmentation of risk layer (130) 7 into risk compartments (120). Scenario 3 involves combining risk layers (130) 8 and 9. Sample calculations are shown for each:

Example calculations are provided below.

### Scenario 1:

In equation 1, Risk layer 6 (shown in FIG. 2) includes three risk compartments (120) subdivided by “products”, including “Products 1 and 2”, “Product 3 only”, and “All remaining risk”. According to FIG. 7b, RC1 corresponds to row 10, and RC2 corresponds to row 11, and RC3 corresponds to row 12. % premium (PP), then, is

Applying equation 1: 0.5+0.7+0.8=2.0%.

### Scenario 2:

In this scenario, risk layer (130) 7 of FIG. 2 shows risk compartments (120) titled, “United States, European Union” labeled (o), and “ROW” labeled (p). An insurer (30) requests that (o) be fragmented into “United States” separately from “European Union”, with the intention of insuring “United States” only. This results in the fragmentation of risk layer (130) 7 from two risk compartments (120) into three. This also results in changes to variables relative to the previously calculated % premium. The change in variables is represented as a percentage change from the previous % premium. Variables affected for scenario 2 include Change in Risk 10% (in row 2), Likelihood 5% (in row 4), Severity 5% (in row 5) and Unwanted 5% (in row 6), which may optionally be applied to only the requested risk compartment (120). Note that layer 7 represents 2% of the total premium as shown in FIG. 5a and row 8 of FIG. 7b. The number of risk compartments will be 3.

Applying equation 2: 2%/(1+10%+5%+5%+5%)/3=0.53%

0.53% of premium for each new risk compartment (120) of risk layer (130) 7 results in a net decrease of 25% of premium to the insurer (20). As calculated, each newly formed risk compartment (120) will suffer the same net decrease. The equation may be adjusted to skew the net decrease to the requesting insurer (30) if desired.

Eq. 2: PP(RLn)*Σ(Risk Factors)/# RCs=RCF % Premium, where (RCF % Premium≤100% of risk layer (120))

### Scenario 3:

In this scenario, risk layer (130) 8 of FIG. 2 is one without risk compartments (120), and has limits from $40M to $45M. Risk layer (130) 9, having limits of $45M to $50M, will be combined into 8. The affected risk layers (130) are only 8 and 9. From FIG. 5a, % premium for layers 8 and 9 are 1.5% and 1%, respectively. Referring to FIG. 7b, the only relevant variable is the Unwanted variable, which is set to −2%. In effect, the new combined layers 8+9 enables the broker (10) to complete the insurance tower (100 or 200) more efficiently, avoiding any risk of having an unwanted layer (130). This resulted in an increase in % of premium to the insurer (30) shown in FIG. 7b as a negative number.

Applying equation 3: (1.5%+1%)/2/(1+(−2%))=1.275%

The combination of insurance layers (130) 8 and 9 resulted in a % premium that is greater than the average of the two layers if not combined, which would have been 1.25% of premium.

It is an object of the present disclosure to automatically calculate variants in real-time to enable both the insurer (30) and the broker (10) to view any pricing adjustments in a private user interface (PUI) (55). This will facilitate rapid and efficient management of the insurance tower (100 or 200) so that complete insurance will be available to the insured (20) in a time period that is suitable to them.

The method described here provides a method for an insurer (30) to change a graphical representation of an insurance tower (100 or 200) wherein the insurance tower (100 or 200) includes:
i. at least three risk layers (130);
ii. provisions for more than one risk compartments (120);
iii. percent of premium associated with each risk layer (130) and risk compartments (120); and
iv. wherein the change may be include adding, deleting, or changing a risk layer (130) or risk compartment (120).

### Blockchain System

In general, a blockchain is a decentralized public ledger of information that functions within the internet. The decentralized public ledger has a network of replicated databases that are synchronized via the internet. The network may be a chain of computers that must all approve a transaction before it can be verified and recorded. The verified block of transactions is then time stamped and added to a chain in a linear chronological order. New blocks are added to old blocks, so that every transaction within that blockchain can be viewed and verified. The entire blockchain is continually updated so that every ledger in the network is the same, giving each member an opportunity to verify each transaction at any given time. The information recorded on a blockchain may include multiple types, such as the transfer of money, ownership, a transaction, or an agreement between multiple parties.

In contrast with traditional agreements which require trust in a lending institution, a law firm, or a business for proper execution of the multiple information types, the blockchain does not rely on centralized entities to establish trust. Instead, cryptology replaces centralized entities as a trusted authority. In a world of international commerce which now includes transactions between individuals in multiple countries, centralized trust entities are typically one-sided. For example, a transaction that involves an individual in the U.S. may prefer a U.S. bank as a trusted authority. But for another individual in China, for example, this individual may have less trust in the U.S. bank.

The blockchain was designed to be transparent, enabled by each public address being open for viewing. It is therefore possible to view the funds, transactions, and details of a public address. These details may be associated with an agreement so that if certain terms are satisfied, the agreement triggers payment that is visible to others.

Although the blockchain is transparent to a public address, the identity of the public-address holder may not be. A user may choose to conceal their identity behind a cryptographic barrier. Thus, the blockchain improves visibility of transactions, although the individuals associated with the transactions may not be known.

With this as background, we turn again to the present disclosure. The blockchain system (60), referenced in FIGS. 1 and 6, is provided for securely managing the insurance tower (100 or 200). The blockchain system (60) manages the approval processes between parties, determines when an event has been triggered, communicates with relevant parties to request authorization, disperses funds and in the correct amounts to the correct parties. Inherent in the blockchain system (60) is the avoidance of fraudulent transactions, redundant payments, contract version disputes, and time-intensive error corrections.

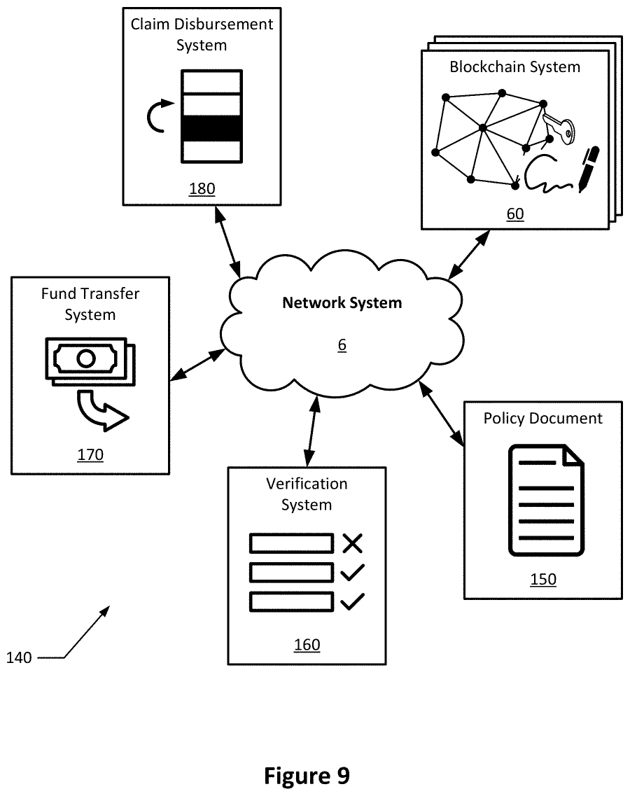

FIG. 9 shows a transaction system (140), which facilitates all transactions related to the ITM system (5) shown in FIG. 1. As shown in FIG. 9, there is a policy document (150) which contains, for example, the terms and conditions for the scope of insurance coverage and for claims made against the policy document (150). There is a verification system (160) that is used to verify that conditions have been satisfied for authorization. A fund transfer system (170) may be triggered upon completion of any verification step within the verification system (160). The fund transfer system (170) may include the transfer of funds from the insured (20) when an insurance policy is bound, dividing a portion of % premium to the broker (10), and further dividing the appropriate 5′ premium to the various insurers (30) that have committed to the insurance tower (100 or 200). A fund transfer may be triggered at the time of a claim, transferring funds to the insured (20) or a third party for settling a claim.

The claim disbursement system (180) is used to determine the applicable rules for disbursement of funds to settle a claim. The claim disbursement system (180) may be under the control of a claims manager that maintains the system, and that enters the claim-specific requirements for settling a claim. Claims management is a dynamic environment that may be informed by any number of events including the nature of the claim, arbitration, settlements, litigation, court orders, and the like. The purpose of the claim disbursement system (180) is to interpret these often-dynamic events for the benefit f the transaction system (140) and incorporate them into the logic of the blockchain system (60). The claim disbursement system (180) will ultimately determine which insurer (30) is responsible for payment of claims (via the fund transfer system (170)) and which portion of any claim should be paid and to which party.

A simple 2D tower, not to be confused with the 2D tower (100) shown in FIG. 2, is represented in Table 1 below.

TABLE 1

| Risk Layer | Lower Limit | Upper Limit | Insurer | |
|---|---|---|---|---|
| (130) | ($M) | ($M) | (30) | % Premium |
| 4 | 10 | 15 | E | 20% |
| 3 | 5 | 10 | C, D, E | 30% |
| 2 | 0.5 | 5 | A, B, C | 50% |
| 1 | N/A | 0.5 | Insured | N/A |
| (SIR 110) | | | (20) | |

The broker (10) established a simple 2D tower (100) in which the insured (20) has an SIR of $0.5M ($500,000) shown in Risk Layer 1, Risk Layer 2 is insured by A, B and C having limits above the SIR to $5M in exchange for collectively receiving 50% of the premium. Risk Layer 3 is insured by C, D and E, having limits from $5M to $10M in exchange for 30% of the premium. Risk Layer 4 is insured by E, having limits from $10M to $15M in exchange for 20% of the premium.

The Network System 6 comprised of the transaction system (140) of FIG. 9 is described more fully. The policy document (150) is coded into the blockchain system (60), which includes the agreed upon premium and the details of Table 1. The policy is bound by the insured (20), submitting the premium to the transaction system (140). The verification process (160) verifies any terms and conditions for distribution of % premium to the parties. Funds are distributed through the fund transfer system (170), which communicates with the electronic banking systems of the insured (20), the broker (10), the various insurers (30), and any government entities for the payment OF premium, taxes, and fees.

The fund transfer system (170) receives a command from the transaction system (140) to distribute 50% of the insurance premium to insurer A, B and C 30% of the insurance premium to the insurer C, D and E, and 20% of the insurance premium to insurer E (less any fees for each).

A claim against the policy requires multiple payments over time as shown in Table 2,

TABLE 2

| | | Claim | Claim | Claim | Claim | Total | Limits | Aggregate |
|---|---|---|---|---|---|---|---|---|
| | | Amount, | Amount, | Amount, | Amount, | Amount | (or SIR) | Policy |
| Insurer | Layer | t1 | t2 | t3 | t4 | Disbursed | Exhausted | Limits/SIR |
| D | | $800,000 | $3,100,000 | $1,200,000 | $600,000 | | | 2 MM |
| C | 4 | | | | $200,000 | $200,000 | No | 2 MM |
| B | 3 | | $400,000 | $1,200,000 | $400,000 | $2,000,000 | Yes | 2 MM |
| A | 2 | $300,000 | $2,700,000 | | | $3,000,000 | Yes | 3 MM |
| | 1 | $500,000 | | | | $500,000 | Yes | 0.5 MM |
| | (SIR) | | | | | | | |

As an example, the first time period t1, a claim of $800,000 is made against the policy. The claim disbursement system (180) verifies the amount owed, sets up conditions for any specific requirements for the disbursal of funds, and communicates to the transaction system (140) that funds are to be collected and from which parties. For the time period t1, $500,000 is collected via the fund transfer system (170) from the insured (20) to satisfy the SIR of $500,000. The next level of payment will be received from Layer 2 via the fund transfer system (170) up to a total of $800k (upper limit of $3M less the SIR of $0.5M). The $300,000 will be deducted from Insurer A via the fund transfer system (170). The total amount of $800,000 is transferred via the fund transfer system (170) to the appropriate receiving parties.

Continuing with the same example, a second claim is made against the policy (150) in a second time period t2, totaling $3.1M. Insurer A has $2.7M of coverage remaining in Layer 2. The claim disbursement system (180) once again verifies the amount owed, sets up conditions for any specific requirements for the disbursal of funds, and communicates to the transaction system (140) that funds are to be collected and from which parties. In this instance, $2.7M is transferred from Insurer A to the fund transfer system (170). There is $400,000 remaining of the $3.1M that is required to satisfy the second claim. The verification system (160) verifies that Insurer B is required to pay this remaining amount, and communicates this to the transaction system (140) for authorization of $400,000 to be transferred from Insurer B. The limits that have been disbursed from Insurer A of $3M exhausts this insurer's limits. Insurer A has no further responsibilities to the insured (20).

There are also shown a claim amount of $1.2M at time t3, and a claim amount of $600k at time t4. In t3, the entire $1.2M is the responsibility of Insurer B. In t4, Insurer B commits the remaining $400k for a total of $2M at which time Insurer B has no further responsibilities to the insured (20). There is $200k remaining that must be assumed by Insurer C in Level 4. The aforementioned processes apply to subsequent claims until all policies are exhausted.

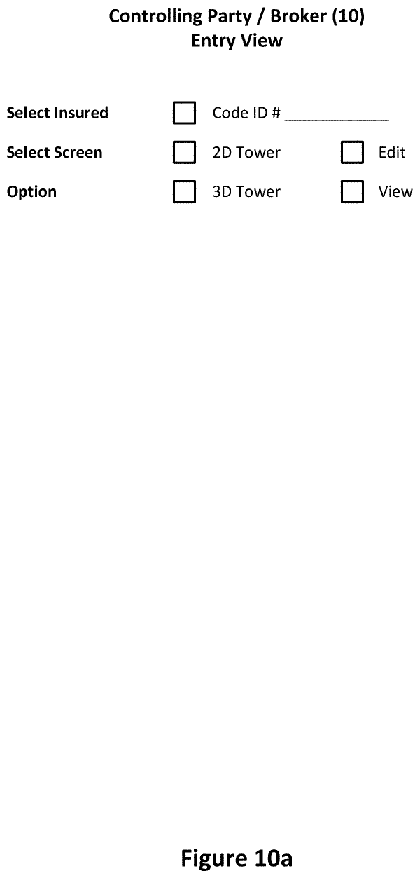

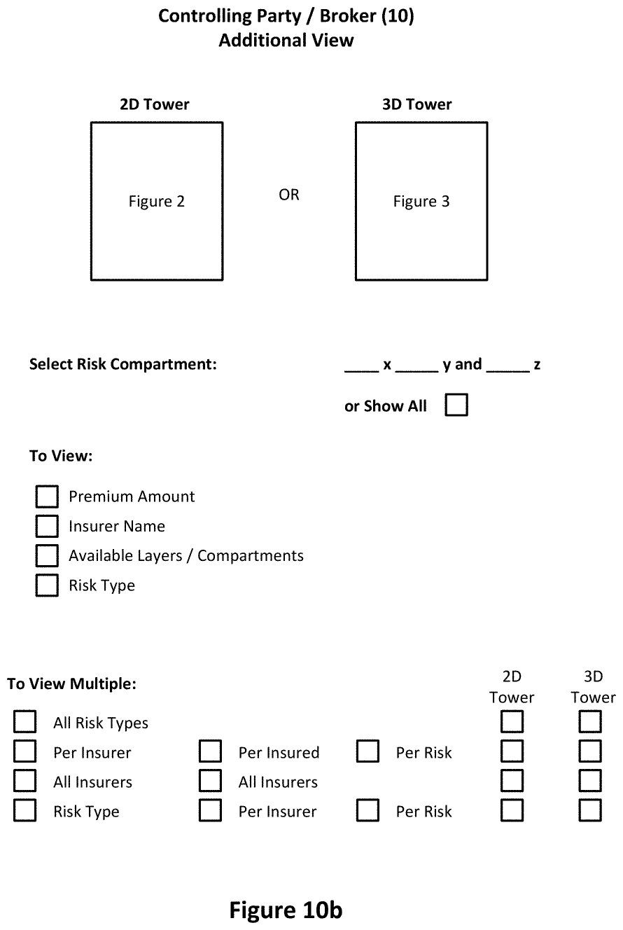

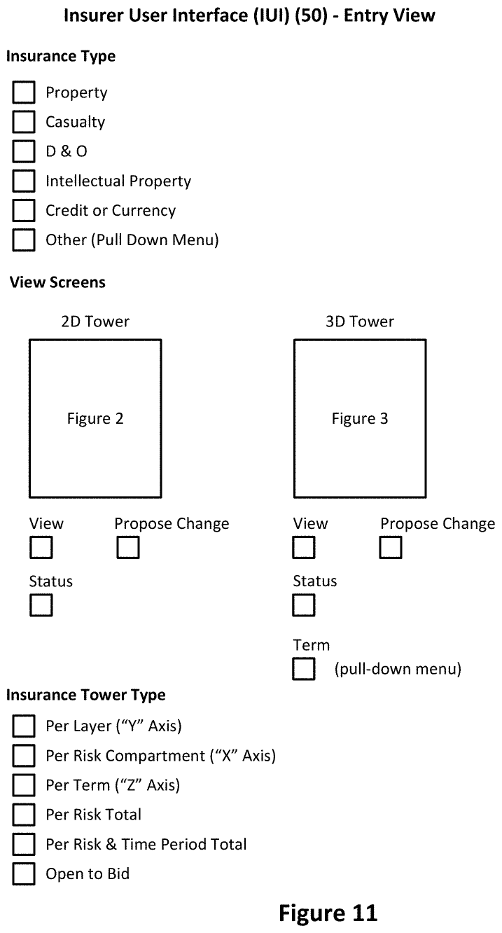

FIG. 10a shows an entry view to a broker user interface (BUI) (40). In this entry view, the broker (10) may select details regarding a specific insured (20) by entering an identifying code (such as a name or number). The broker (10) may open an insurance tower (100 or 200), and has the option to open the insurance tower (100 or 200) in “edit” or “view” mode.

FIG. 10b shows an additional view of a broker user interface (BUI) (40). FIG. 10b shows options available to the broker (10) for editing or modifying an insurance tower (100 or 200). The broker (10) may select on “2D Tower” to edit a 2D tower (100) as shown in FIG. 2. Alternately the broker (10) may select on “3D Tower” to edit a 3D Tower (200) as shown in FIG. 3. The broker (10) may select a specific risk compartment by entering the x, y, and z components or may alternately opt to “Select All”. Various features may be viewed, including Premium Amount, Insurer (30) Name, Available risk compartments (120) or risk layers (130), or risk type. Alternately, the broker (10) may view multiple features at once.

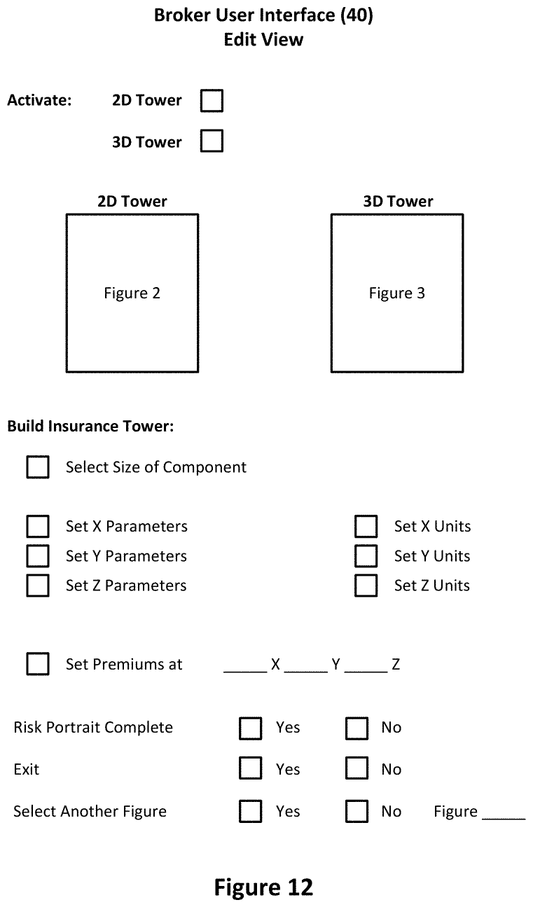

FIG. 11 shows an entry view to an insurer's user interface (IUI) (50). FIG. 11 shows options available to the insurer (30) for viewing an insurance tower (100 or 200). The insurer (30) may view the available insurance towers (100 or 200) by insurance type (such as Property, Casualty, D&O, and so on). The insurer (30) may then select on a 2D Tower or 3D Tower view. As discussed in the disclosure, the insurer (30) may view or propose a change to the insurance tower (100 or 200) or view the status of the insurance tower (100 or 200) at that current time. In the 3D tower (200) view, the term (normally in years) can be viewed. There are also shown additional viewing options based on insurance tower (100 or 200) type.

FIG. 12 shows a BUI (40) Edit View in which a broker (10) may activate a 2D tower (100) or 3D tower (200). The broker (10) may build the insurance tower (100 or 200) by selecting the size of each component of the insurance tower (100 or 200), or by setting specific parameters corresponding to x, y, and z positions in the insurance tower (100 or 200). The units for the insurance tower (100 or 200) may also be set. Units may include, for example, the monetary denomination (U.S. Dollars, Euros, Cryptocurrency and the like) for the y-axis, and graduation of % of risk layer for the x-axis.

1. A computer-implemented method for placing insurance coverage with one or more insurers, comprising:
providing, by one or more computer systems having computer processors and input devices, a broker user interface for one or more controlling parties, wherein the broker user interface comprises computer-readable instructions for creating a) more than one risk layers and b) optionally representing more than one risk compartments, wherein each cell is capable of more than one status;
generating, by one or more computer systems having computer processors and display devices, a graphical display of the more than one cells representing more than one risk layers and optionally representing more than one risk compartments, wherein the graphical display is capable of viewing by at least an insurer user interface for one or more insurers;
receiving, by one or more computer systems having computer processors, instructions from the insurer user interface for an action including selecting or bidding on at least one cell representing at least one risk layers or risk compartments, wherein selecting or bidding on at least one cell will automatically send a command to the computer processor of a change from a first status to another status;
providing, by one or more computer systems having computer processors and input devices, any change in status to the one or more controlling parties;
receiving; by one or more computer systems having computer processors, instructions from the one or more controlling parties to provide a response to any cell having a change in status, wherein the response may include one of an acceptance, a bid, and a counter-bid;
causing, by one or more processors, automatic binding of insurance coverage for any cells that have received a response from any of the one or more controlling parties for an acceptance of an action.

2. A computer-implemented method for calculating real-time adjustments in insurance risk towers, comprising:
providing, by one or more computer systems having computer processors and input devices, a user interface for displaying an insurance risk tower having at least three layers;
providing, by one or more computer systems having computer processors and input devices, a user interface to one or more brokers, wherein the one or more brokers may create a graphical representation of one or more insurance risk towers;
providing, by one or more computer systems having computer processors and input devices, a user interface to one or more insurers, wherein the one or more insurers may create one or more variants in the one or more insurance risk towers;
providing a database that is functionally connected to the graphical representation of at least one insurance risk tower, wherein the database is capable of calculating variants in the at least one insurance risk tower;
providing a blockchain system for authorizing one or more bids or variants in the insurance risk towers;
calculating, by the database that is functionally connected to a graphical representation of at least one insurance risk tower, one or more variants associated with a bid that has been authorized by the blockchain system in the one or more insurance risk towers;
causing, by calculations associated with the one or more variants, a change to the graphical representation of the one or more insurance risk towers.

3. A computer implemented method for placing insurance coverage with one or more insurers comprising:
providing, by one or more computer systems having computer processors and input devices, a user interface, wherein the user interface provides computer-readable compartments represented by a) one or more risk layers or compartments within a larger potential risk including at least minimum policy limits, wherein each layer or compartment is capable of more than one status;
generating, a graphical display of the one or more layer or compartment wherein the graphical display is capable of viewing by at least one insurer or user; said user or insurer selecting or bidding on at least one cell representing an offer to provide insurance within at least one risk layer or risk compartment, wherein said offer changes the status of the layer or compartment.
